(19) United States
(12) Patent Application Publication
(10) Pub. No.: US 2007/0044925 A1
(43) Pub. Date: Mar. 1, 2007

(54) Lockable cord pulling device

(76) Inventor: Tai-Long Huang, Changha (TW)

Correspondence Address: GALLAGHER & LATHROP, A PROFESSIONAL CORPORATION, 601 CALIFORNIA ST, SUITE 1111, SAN FRANCISCO, CA, 94108, US

(21) Appl. No.: 11/213,482

(22) Filed: Aug. 25, 2005

(51) Int. Cl. E06B 9/324

(52) U.S. Cl. 160/178.2

(57) ABSTRACT

A lockable cord pulling device includes a mounting member having a vertically extending abutment wall, and a pulley roller rotatably mounted on the mounting member, a pull cord trained on the pulley roller to form an underlying region that cooperates with the abutment wall to define a moving route oriented in a vertical direction, and a lock roller movable along the moving route. When the pull cord is pulled to bring the underlying region into frictional engagement with the lock roller, subsequent downward pulling of the pull cord in an upright direction to tense the underlying region will cause the lock roller to roll to a locked position, where the lock roller is stuck between the pulley roller and the abutment wall. The lock roller is allowed to fall into an unlocked position by virtue of gravity once the pull cord is pulled leftwards.

### BACKGROUND OF THE INVENTION

1. Field of the Invention

This invention relates to a lockable cord pulling device, more particularly to a lockable cord pulling device adapted to be mounted on a header unit of a window covering for raising and lowering a lowermost slat relative to the header unit in an upright direction.

2. Description of the Related Art

Referring to FIGS. 1 and 2, in U.S. Pat. No. 4,945,970, entitled “Cord Lock Unit For Drape Or Blind Assembly,” there is disclosed a cord lock unit which includes a mounting member 3 secured in an opening of a header unit 1 of a horizontal blind assembly (not shown), a pulley roller 4 rotatably mounted on a mount wall 302 of the mounting member 3, a pull cord 2 trained on the pulley roller 4 to raise and lower blind slats of the blind assembly, a lock roller 5 disposed in the mounting member 3, and a retaining pin 6 extending between two ends of the mounting member 3 to prevent removal of the lock roller 5. The mounting member 3 has a bottom wall 301, a pair of resilient tongues 303 extending from two ends of the bottom wall 301 so as to resiliently engage the opening of the header unit 1, and a ramp 304 extending from the bottom wall 301 and having a plurality of ribs 306 formed thereon. As shown in FIG. 1, the lock roller 5 is clamped between the pulley roller 4 and the ramp 304 by means of the pull cord 2 so as to position the blind slats at a desired height. When it is desired to lower the blind slats, the pull cord 2 is positioned in an angular position shown in solid lines in FIG. 2, and is pulled downwardly. Such downward movement releases the lock roller 5 from its engagement with the ramp 304 and allows the lock roller 5 to fall into the position shown in FIG. 2. When the pull cord 2 is pulled to raise the blind slats with the pull cord 2 angularly disposed as shown in phantom outline in FIG. 2, engagement of the pull cord 2 with the lock roller 5 will cause the lock roller 5 to engage the ramp 304, and the resulting rotation of the lock roller 5 will in turn cause the pull cord 2 to move upwardly along the ramp 304 by virtue of the engagement of ribs on the lock roller 5 with the ribs 306 on the ramp 304. Such upward movement will continue until the lock roller 5 is in the position shown in FIG. 1. However, since the lock roller 5 is moved along the ramp 304, the pull cord 2 must be pulled rightwardly to release the engagement of the lock roller 5 with the cord 2, thereby resulting in inconvenient operation. Besides, since the cord lock unit is often mounted on a right side of the header unit 1, the mounting member 3 may be in close proximity to a wall of a room, thereby rendering rightward pulling of the pull cord 2 difficult and inconvenient.

### SUMMARY OF THE INVENTION

The object of the present invention is to provide a lockable cord pulling device, in which the angle of a pull cord relative to a vertical direction when the pull cord is operated to raise or lower slats of a window covering or to position the slats at a desired height is relatively small, thereby rendering operation of the pull cord convenient. Besides, operation of the pull cord will not be affected even if the window covering is in close proximity to a wall of a room.

According to this invention, the lockable cord pulling device includes a mounting member, a pulley roller, a pull cord, and a lock roller. The mounting member includes a mount wall which is adapted to be disposed in a header unit of a window covering, and which extends towards a right end of the header unit to terminate at a lateral edge, an abutment wall which is disposed proximate to the lateral edge, which extends in a transverse direction, and which includes upper and lower areas opposite to each other in a vertical direction, and an axle which extends from the mount wall along a rotating axis in the transverse direction, and which cooperates with the upper area to define a line of length that is radial to the rotating axis, and that is normal to the upper area. The pulley roller is rotatably mounted on the axle about the rotating axis, and has a pulley rim that intersects the line of length at a cord engaging point. The pull cord has an actuated end adapted to couple with a lowermost slat of the window covering, a pulled end opposite to the actuated end, and a guided segment which is interposed between the actuated end and the pulled end, and which is trained on the pulley rim so as to form an underlying region that is between the cord engaging point and the pulled end, and that cooperates with the abutment wall to define a moving route oriented in the vertical direction. The lock roller has a roller rim, and is disposed to be movable along the moving route between an unlocked position where the lock roller is rested closer to the lower area, and a locked position where the lock roller is suspended closer to the upper area. The lock roller is configured such that once the pulled end is pulled to bring the underlying region of the pull cord into frictional engagement with the roller rim, subsequent downward pulling of the pulled end along a path in the upright direction to tense the underlying region will force the lock roller to turn counterclockwise so as to roll across the lower area along the moving route to the locked position, where the lock roller is stuck between the pulley rim and the abutment wall by virtue of an increased dragging force of the underlying region which acts on the roller rim and which is generated as a result of said roller rim approaching the cord engaging point, and such that the lock roller is relieved from the increased dragging force and is allowed to fall into the unlocked position by virtue of gravity once the pulled end is pulled leftwards away from the path to tense the underlying region.

### BRIEF DESCRIPTION OF THE DRAWINGS

Other features and advantages of the present invention will become apparent in the following detailed description of the preferred embodiment of the invention, with reference to the accompanying drawings, in which:

FIG. 1 is a sectional view of a conventional cord lock unit in a cord-locked state;

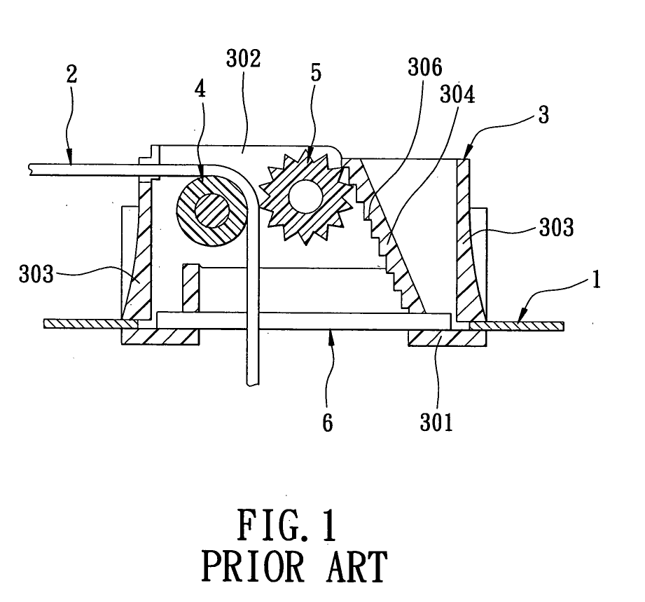

FIG. 2 is a sectional view of the conventional cord lock unit in a cord-unlocked state;

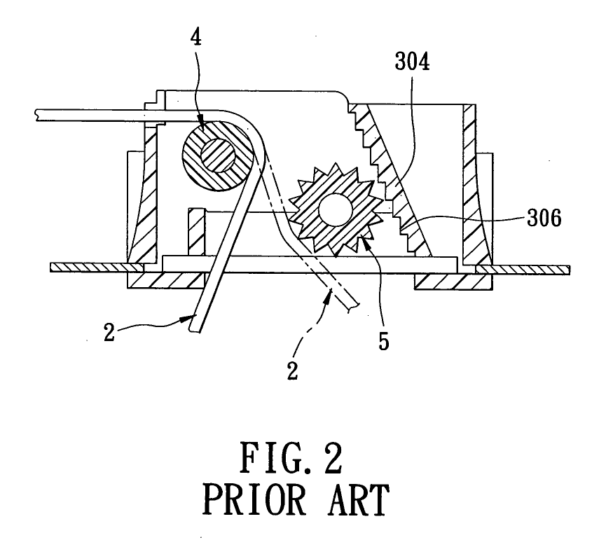

FIG. 3 is a fragmentary sectional view of the preferred embodiment of a lockable cord pulling device according to this invention;

FIG. 4 is a fragmentary sectional view showing that a pull cord of the preferred embodiment is pulled leftwards to move a lock roller from a locked position to an unlocked position; and

FIG. 5 is a fragmentary sectional view showing that the pull cord of the preferred embodiment is pulled in an upright direction to move the lock roller from the unlocked position to the locked position.

### DETAILED DESCRIPTION OF THE PREFERRED EMBODIMENT

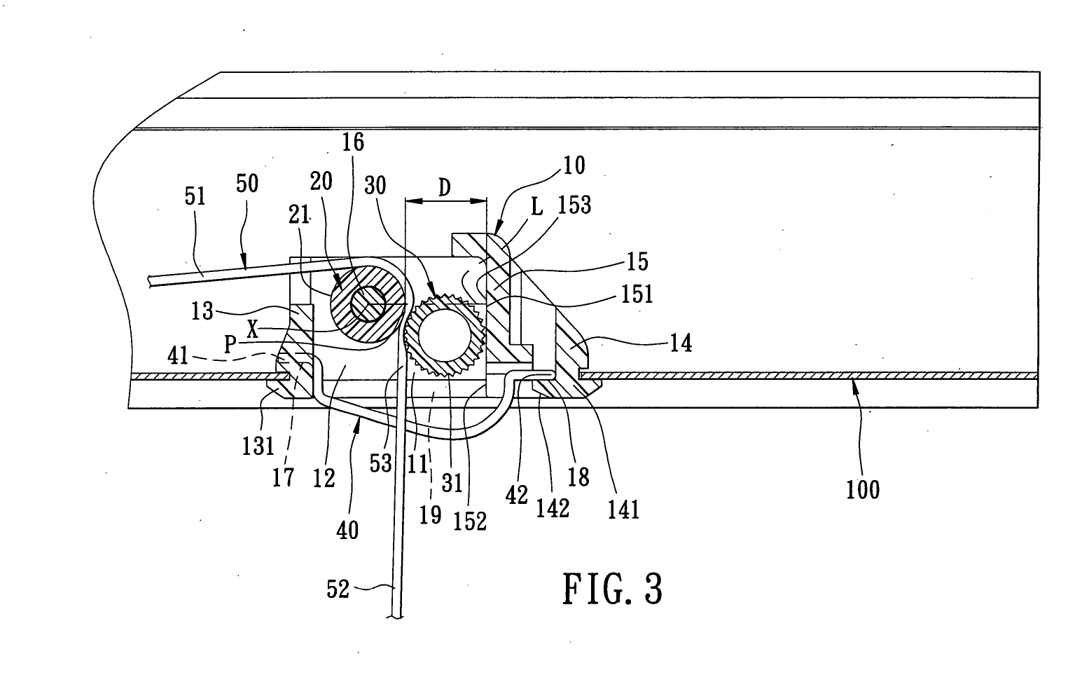

Referring to FIG. 3, the preferred embodiment of a lockable cord pulling device according to the present invention is adapted to be mounted on a header unit 100 of a window covering (not shown) for raising and lowering a lowermost slat (not shown) relative to the header unit 100 in an upright direction. The header unit 100 extends to terminate at left and right ends in a longitudinal direction transverse to the upright direction. The lockable cord pulling device comprises a mounting member 10, a pulley roller 20, a pull cord 50, a lock roller 30, and a leaf spring 40. It is noted that the lockable cord pulling device of this invention is assumed to be mounted adjacent to the right end of the header unit 100 in the description to follow.

The mounting member 10 includes a pair of mount walls 12 which are adapted to be disposed in the header unit 100, which are spaced apart from each other in a transverse direction relative to both the upright and longitudinal directions, and each of which extends towards the right end to terminate at a lateral edge, an abutment wall 15 which is disposed proximate to the lateral edge, which extends in the transverse direction, and which has an abutment surface 151 that extends in a vertical direction and that includes upper and lower areas 153, 152 opposite to each other in the vertical direction, a right engaging wall 14 which resiliently extends from the lateral edges of the mount walls 12 in the transverse direction, and a left engaging wall 13 which is spaced apart from the abutment wall 15 and the right engaging wall 14 in the longitudinal direction. The right and left engaging walls 14, 13 extend downwardly to terminate at right and left bottom edges 141, 131, respectively, which define an access opening 19 therebetween. The left and right bottom edges 131, 141 respectively have left and right engaging holes 17, 18. An axle 16 extends from one of the mount walls 12 along a rotating axis (X) in the transverse direction, and cooperates with the upper area 153 to define a line of length (L) that is radial to the rotating axis (X), and that is normal to the upper area 153. When the mounting member 10 is mounted in the header unit 100, the left engaging wall 13 is first engaged with an inner edge of the header unit 100, and the right engaging wall 14 is then engaged with an opposite inner edge of the header unit 100 by virtue of its resilience.

The pulley roller 20 is rotatably mounted on the axle 16 about the rotating axis (X), and has a pulley rim 21 which intersects the line of length (L) at a cord engaging point (P). The pull cord 50 has an actuated end 51 adapted to couple with the lowermost slat, a pulled end 52 opposite to the actuated end 51, and a guided segment which is interposed between the actuated end 51 and the pulled end 52, and which is trained on the pulley rim 21 so as to form an underlying region 53 that is between the cord engaging point (P) and the pulled end 52, and that cooperates with the abutment wall 15 to define a moving route 11 oriented in the vertical direction and communicated with the access opening 19.

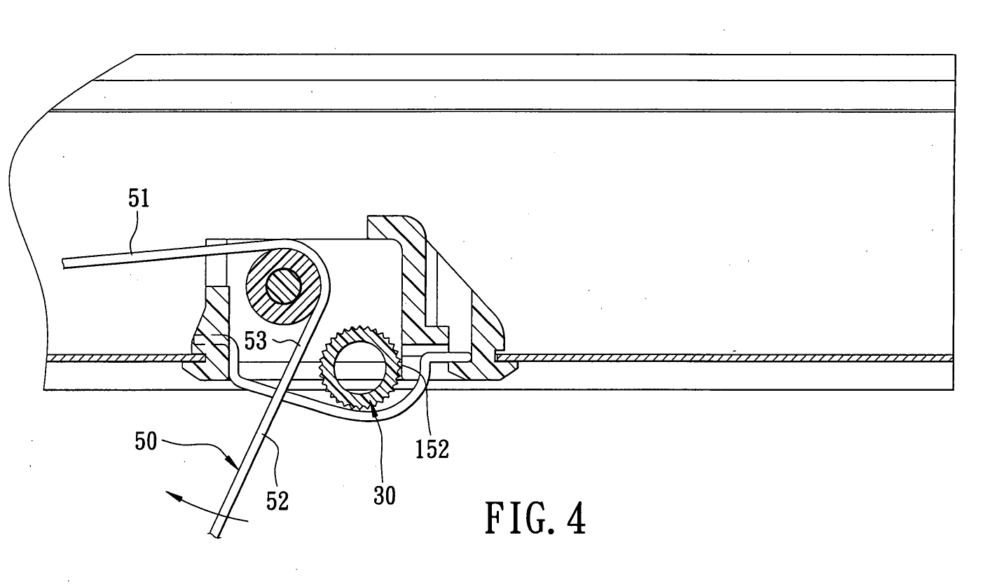

The lock roller 30 has a roller rim 31, is received in the moving route 11 from the access opening 19, and is movable along the moving route 11 between an unlocked position, as shown in FIG. 4, where the lock roller 30 is rested closer to the lower area 152, and a locked position, as shown in FIG. 3, where the lock roller 30 is suspended closer to the upper area 153. In this embodiment, a space interval (D) between the cord engaging point (P) and the abutment surface 151 is smaller than the sum of an outer diameter of the lock roller 30 and a thickness of the pull cord 50. In addition, since the abutment surface 151 extends in the vertical direction, space intervals between the underlying region 53 and the lower area 152 and between the underlying region 53 and the upper area 153 are the same when the pulled end 52 is pulled to move the lock roller 30 along the moving route 11.

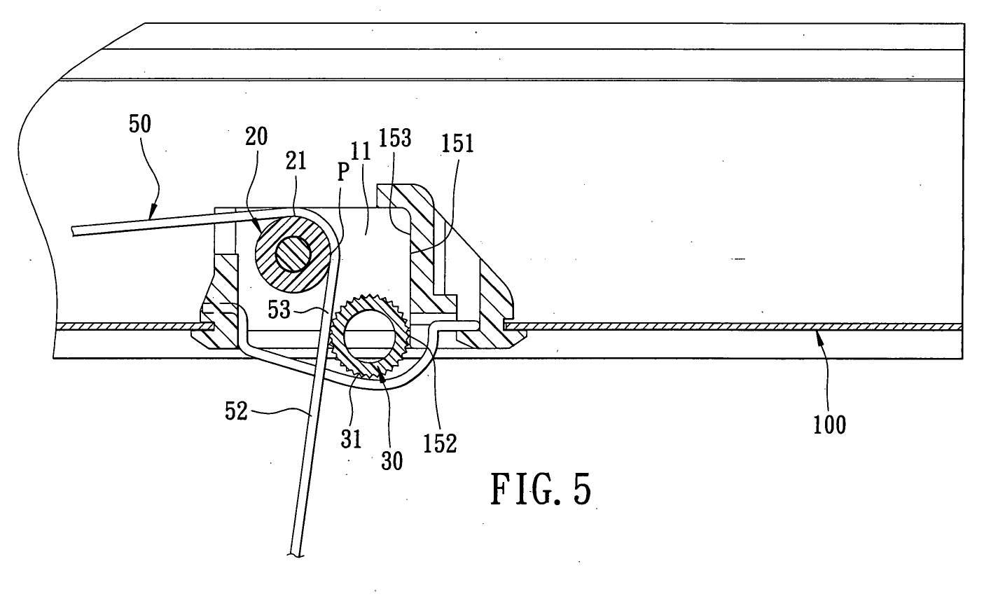

Therefore, when it is desired to move the lock roller 30 to the locked position, as shown in FIG. 5, the pulled end 52 is pulled to bring the underlying region 53 of the pull cord 50 into frictional engagement with the roller rim 31 of the lock roller 30. Subsequent downward pulling of the pulled end 52 along a path in the upright direction (i.e. substantially in the vertical direction) to tense the underlying region 53 will force the lock roller 30 to turn counterclockwise so as to roll across the lower area 152 along the moving route 11 to the locked position, where the lock roller 30 is stuck between the pulley rim 21 of the pulley roller 20 and the abutment surface 151 by virtue of an increased dragging force of the underlying region 53 which acts on the roller rim 31 and which is generated as a result of the roller rim 31 approaching the cord engaging point (P), as shown in FIG. 3. Thus, the lowermost slat of the window covering can be held at a desired height by the pull cord 50.

Moreover, when it is desired to move the lock roller 30 to the unlocked position, as shown in FIG. 4, the pulled end 52 is pulled leftwards away from the path to tense the underlying region 53, and the lock roller 30 is relieved from the increased dragging force so that the lock roller 30 falls into the unlocked position by virtue of the gravity thereof. Thus, the lowermost slat of the window covering can be smoothly raised and lowered by operating the pull cord 50.

The leaf spring 40 has left and right spring ends 41, 42 which are respectively inserted into the left and right engaging holes 17, 18 such that the leaf spring 40 extends across the access opening 19 to prevent removal of the lock roller 30 from the access opening 19. Preferably, the right bottom edge 141 has a guiding surface 142 that is formed to be communicated with the right engaging hole 18 so as to facilitate insertion of the right spring end 42 of the leaf spring 40 into the right engaging hole 18.

As illustrated, since the abutment surface 151 extends in the vertical direction, the angle of the pulled end 52 relative to the vertical direction when the pulled end 52 is operated to raise or lower the lowermost slat (i.e. the lock roller 30 is moved in the unlocked position) or to position the lowermost slat at a desired height (i.e. the lock roller 30 is moved to the locked position) can be quite small. Thus, the operation of the pull cord 50 is convenient and will not be affected by the surrounding conditions, especially when the pull cord 50 is disposed in close proximity to a wall of the room. Moreover, during assembly, the left spring end 41 of the leaf spring 40 can be first inserted into the left engaging hole 17, and the right spring end 42 is then inserted into the right engaging hole 18 guided by the guiding surface 142. Thus, assembly of the leaf spring 40 can be easily conducted without the need to use any tools.

While the present invention has been described in connection with what is considered the most practical and preferred embodiment, it is understood that this invention is not limited to the disclosed embodiment but is intended to cover various arrangements included within the spirit and scope of the broadest interpretations and equivalent arrangements.

I claim:

1. A lockable cord pulling device adapted to be mounted on a header unit of a window covering for raising and lowering a lowermost slat relative to the header unit in an upright direction, the header unit extending to terminate at left and right ends in a longitudinal direction transverse to the upright direction, said lockable cord pulling device comprising:
a mounting member including
a mount wall adapted to be disposed in the header unit, and extending towards the right end to terminate at a lateral edge,
an abutment wall which is disposed proximate to said lateral edge, which extends in a transverse direction relative to both the upright and longitudinal directions, and which includes upper and lower areas opposite to each other in a vertical direction, and
an axle which extends from said mount wall along a rotating axis in the transverse direction, and which cooperates with said upper area to define a line of length that is radial to the rotating axis, and that is normal to said upper area;
a pulley roller which is rotatably mounted on said axle about the rotating axis, and which has a pulley rim that intersects the line of length at a cord engaging point;
a pull cord having an actuated end adapted to couple with the lowermost slat, a pulled end opposite to said actuated end, and a guided segment which is interposed between said actuated end and said pulled end, and which is trained on said pulley rim so as to form an underlying region that is between the cord engaging point and said pulled end, and that cooperates with said abutment wall to define a moving route oriented in the vertical direction; and
a lock roller which has a roller rim, and which is disposed to be movable along said moving route between an unlocked position where said lock roller is rested closer to said lower area, and a locked position where said lock roller is suspended closer to said upper area, said lock roller being configured such that once said pulled end is pulled to bring said underlying region of said pull cord into frictional engagement with said roller rim, subsequent downward pulling of said pulled end along a path in the upright direction to tense said underlying region will force said lock roller to turn counterclockwise so as to roll across said lower area along said moving route to the locked position, where said lock roller is stuck between said pulley rim and said abutment wall by virtue of an increased dragging force of said underlying region which acts on said roller rim and which is generated as a result of approaching the cord engaging point, and such that said lock roller is relieved from the increased dragging force and is allowed to fall into the unlocked position by virtue of gravity once said pulled end is pulled leftwards away from the path to tense said underlying region.

2. The lockable cord pulling device of claim 1, wherein said abutment wall of said mounting member extends in the vertical direction such that space intervals between said underlying region and said lower area and between said underlying region and said upper area are the same when said pulled end is pulled to move said lock roller along the moving route.

3. The lockable cord pulling device of claim 2, wherein a space interval between said cord engaging point and said abutment wall is smaller than sum of an outer diameter of said lock roller and a thickness of said pull cord.

4. The lockable cord pulling device of claim 1, wherein said mounting member further includes a right engaging wall which extends from said lateral edge of said mount wall in the transverse direction, and a left engaging wall which is spaced apart from said abutment wall and said right engaging wall in the longitudinal direction, said right and left engaging walls extending downwardly to terminate at right and left bottom edges, respectively, which define therebetween an access opening that is communicated with said moving route so as to permit said lock roller to access said moving route, said left and right bottom edges respectively having left and right engaging holes, said device further comprising a leaf spring which has left and right spring ends respectively inserted into said left and right engaging holes such that said leaf spring extends across said access opening to prevent removal of said lock roller from said access opening.

5. The lockable cord pulling device of claim 4, wherein said right bottom edge has a guiding surface formed to be communicated with said right engaging hole so as to facilitate insertion of said right spring end of said leaf spring into said right engaging hole.
